(19) United States
(12) Patent Application Publication
(10) Pub. No.: US 2009/0077725 A1
(43) Pub. Date: Mar. 26, 2009

(54) Protective garment for use by a firefighter or other emergency worker wearing a weight-bearing harness over the exterior of the protective garment

(76) Inventors: Patricia K. Waters, Tipp City, OH (US); Mary I. Grilliot, Dayton, OH (US); William L. Grilliot, Dayton, OH (US); William L. Grilliot, JR., Dayton, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/903,114

(22) Filed: Sep. 20, 2007

(51) Int. Cl. A62B 17/00; A41D 1/06; A41D 13/00; A62B 35/00; A41D 3/02

(52) U.S. Cl. 2/458; 182/3; 2/227; 2/81; 2/93; 2/97

(57) ABSTRACT

A protective garment (10) is provided for use by a firefighter or other emergency worker in connection with a weight-bearing harness (24,30) worn by the firefighter or other emergency worker over the exterior of the protective garment (10). The protective garment (10) includes an outer shell (40), a moisture barrier liner (42) within the outer shell (40), and a wear reduction structure (50) between the outer shell (40) and the moisture barrier liner (42) to reduce wear of the moisture barrier liner (42) caused by the harness (24,30) when worn by a firefighter or other emergency worker.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to protective garments worn by firefighters and other emergency workers and to weight-bearing harnesses such as are used with a self-contained breathing apparatus (SCBA) and/or climbing or fall protection harnesses.

### BACKGROUND OF THE INVENTION

It is common for firefighters and other emergency workers to wear a self-contained breathing apparatus (SCBA) having an air tank that is carried on the back of the firefighter by a harness that will typically include shoulder straps and a waist strap worn over the coat of their turnout gear. It is also common for firefighters to wear a climbing or fall protection harness over the pants of their turnout gear. One problem that can occasionally occur is wear in the portions of the protective coat or pants that underlie and support the harnesses due to the weight and rubbing of the straps of the harness. This is particularly a problem with the moisture barrier liners of such garments, which do not have the same durability and/or wear resistance as the outer shell of the garment.

### SUMMARY OF THE INVENTION

In accordance with one feature of the invention, a protective garment is provided for use by a firefighter or other emergency worker in connection with a weight-bearing harness worn by the firefighter or other emergency worker over the exterior of the protective garment. The protective garment includes an outer shell, a moisture barrier liner within the outer shell, and a wear reduction structure between the outer shell and the moisture barrier liner to reduce wear of the moisture barrier liner caused by the harness when worn by a firefighter or other emergency worker. The wear reduction structure is limited to at least one zone selected to underlie the harness.

In one feature, the protective garment is a coat and the wear reduction structure is located in at least one of a waist portion of the coat to underlie a waist harness and a shoulder portion of the coat to underlie a shoulder harness.

As one feature, the wear reduction structure extends downward from the waist portion to adjacent a bottom of the coat.

According to one feature, the coat has a collar and a pair of sleeves and the wear reduction structure extends from the collar to each of the sleeves.

As one feature, the protective garment is a pair of pants and the wear reduction structure is located in at least one of a waist portion of the pants and a pair of upper thigh portions of the pants.

In one feature, the wear reduction structure is located in the waist portion of the pants.

According to one feature, the wear reduction structure extends from the waist portion to a pair of upper thigh portions of the pants.

As one feature, the wear reduction structure is located in each of the upper thigh portions of the pants.

According to one feature, the wear reduction structure includes a series of cushioning pads spaced throughout the at least one zone.

In one feature, the wear reduction structure includes a series of elongate cushioning strips extending through the at least one zone. As one feature, the strips extend longitudinally with respect to the coat. In another feature, the strips extend transverse with respect to the coat.

According to one feature, the wear reduction structure includes an additional layer of material extending throughout the zone.

In one feature, the additional layer is made from the same material as the moisture barrier liner.

As one feature, the moisture barrier liner and the additional layer are made from different materials.

In one feature, the additional layer is made from a moisture barrier material having a greater resistance to wear than the material of the moisture barrier liner.

According to one feature, the protective garment further includes a thermal insulative liner located inside of the moisture barrier liner, and the additional layer and the thermal insulative liner are made from the same material.

As one feature, the wear reduction structure is fixed to the moisture barrier liner.

Other objects, features, and advantages of the invention will become apparent from a review of the entire specification, including the appended claims and drawings.

### BRIEF DESCRIPTION OF THE DRAWINGS

FIG. 1 is a perspective view from the side of a fireman or other emergency worker wearing protective garments embodying the present invention, as well as a SCBA;

FIG. 2 is a perspective view from the front of the fireman of FIG. 1 showing the pair of pants of the protective garments with a climbing or fall protection harness worn over the pair of pants;

FIG. 3 is a section view taken along any of the section lines 3-3 in FIGS. 1 and 2;

FIG. 4A is an exploded perspective view of FIG. 3;

FIGS. 4B and 4C are exploded perspective views similar to FIG. 4A but showing alternate embodiments for selected components of FIG. 4A; and

FIG. 5 is a view similar to FIG. 3, but showing an alternate embodiment of the invention.

### DETAILED DESCRIPTION OF THE PREFERRED EMBODIMENT

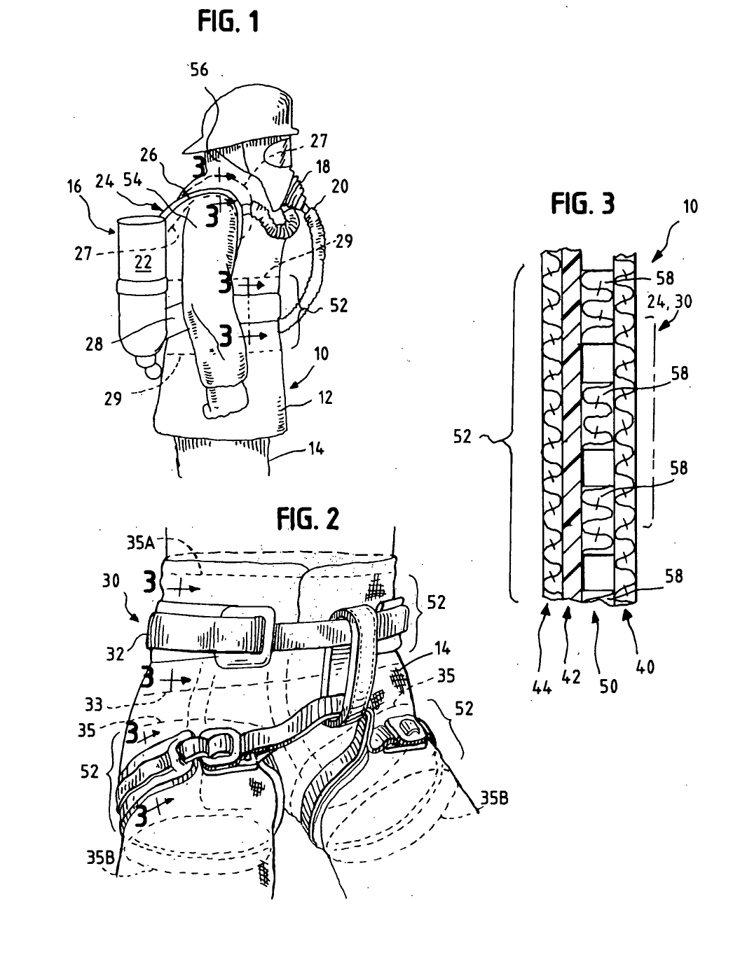

With reference to FIGS. 1 and 2, a firefighter or other emergency worker is shown wearing protective garments 10 in the form of a coat 12 and pair of pants 14. As seen in FIG. 1, the firefighter is wearing a self-contained breathing apparatus 16 that includes a respirator 18 connected by a hose 20 to an oxygen/air tank 22 that is carried on the back of the firefighter by a harness 24. The harness 24 includes a pair of shoulder straps 26 (only one shown in FIG. 1), each extending over a corresponding shoulder portion of the coat generally indicated by dashed lines 27, and a waist strap 28 extending over a waist portion of the coat generally indicated by dashed lines 29. With reference to FIG. 2, it can be seen that the firefighter is wearing a climbing or fall protection harness 30 that includes a waist strap 32 extending around a waist portion of the pair of pants generally indicated by dashed lines 33, and a pair of upper thigh straps 34 extending over an upper thigh portion of the pair of pants 14 generally indicated by dashed lines 35.

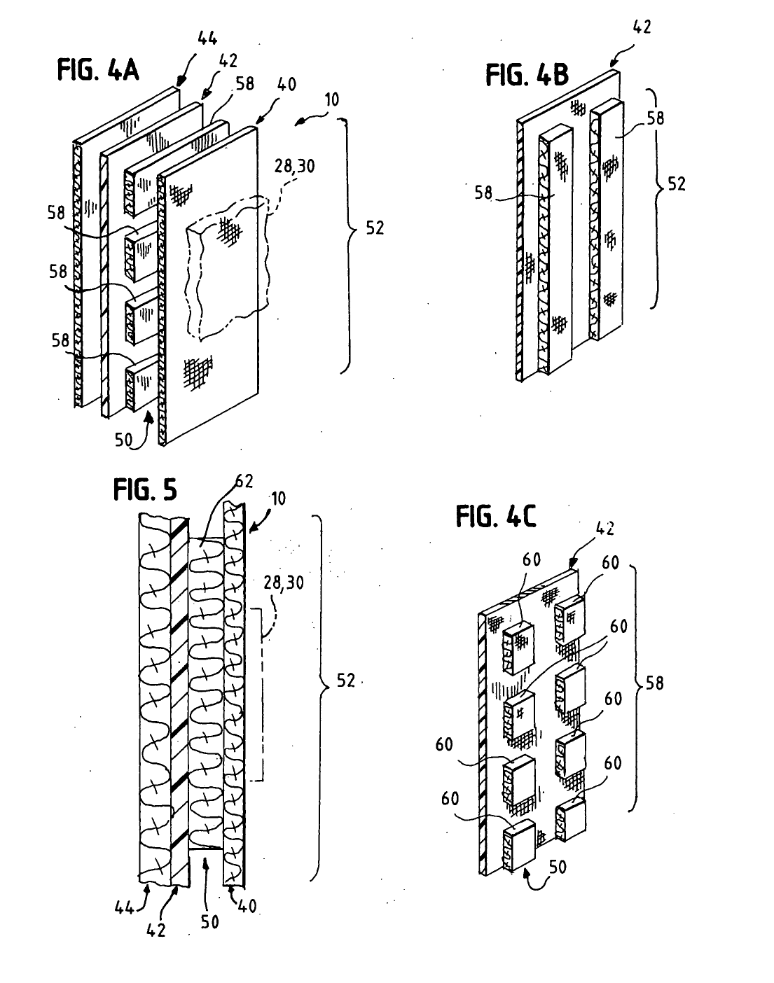

With reference to FIGS. 3 and 4, both the coat 12 and the pair of pants 14 are of a multi-layered construction consisting of an outer shell 40, a moisture barrier liner 42, and optionally, but preferred, a thermal insulating barrier lining 44. Each of the layers 40, 42 and 44 can be made from suitable fabrics for each of their particular functions, many of which are known. For example, the outer shell 40 can be made from any suitable fire resistant, thermal resistant, and/or wear resistant (i.e., resistant to cuts, snags, tears, and abrasions) material, some examples of which include Kevlar®, Nomex®, Basofil, PBI (polybenzimidazole), and PBO (poly(p-phenylene-benzobisoxazole)) materials. The moisture barrier liner 42 can be made of any suitable material that will be highly resistant to passage of liquid, particularly liquid water, through the material, some examples of which include Crosstech® material (breathable) or neoprene (non-breathable). Additionally, the moisture barrier materials 50 and 51 can also be highly resistant to chemicals so that they act also as a chemical barrier. One example of such a material is supplied by W.L. Gore & Associates, Inc. under the CHEMPAK® trademark.

The thermal insulative liner 44 can be made of a suitable thermal insulating material or construction, such as nonwoven batting, closed cell foam, and Basofil/Aramid batting sandwiched between face layers of a suitable breathable fabric.

The protective garments 10 also include a wear reduction structure 50 between the outer shell 40 and the moisture barrier liner 42 to reduce wear of the moisture barrier liner 42 caused by the harness 24 or 30 when worn by a firefighter over the protective garments 10. The wear reduction structure 50 is limited to one or more of zones 52 that underlie the harness 24 or 30, with the remaining portions of the garments 10 that do not underlie the harnesses 24 or 30 being free of the wear reduction structure 50. In this regard, it should be noted that the zones 52 will preferably be larger than the associated straps 26,28,32,34 to allow for variability in positioning of the harnesses 24 and 30 on the fireman which will naturally occur during use, and from one use to the next of the harness 24 or 30. In this regard, for the illustrated embodiments, the zones 52 can be considered as being defined between the dashed lines 27 for the shoulder strap 26 of the harness 24, between the dashed lines 29 for the waist strap 28 of the harness 24, between the dashed lines 33 for the waist strap 32 of the harness 30, and between the dashed lines 35 for the thigh straps 34 for the harness 30. It should be appreciated that other zones 52 are possible depending upon the particular construction of a harness. Furthermore, it will be appreciated that the zones 52 may only be required in only part of the area of the garment 10 that underlies a particular harness. For example, the wear reduction structure 50 for use in connection with the shoulder strap 26 of the harness 24 may only be required in a part of the coat 12 that extends from the sleeves 54 of the coat 12 to the collar 56 of the coat 12. On the other hand, again depending upon the particular construction of the harness, it may be convenient to extend the wear reduction structure 50 between closely adjacent zones 52. For example, for the harness 30 shown in FIG. 2, it may be convenient for the wear reduction structure 50 to be provided between the upper line 33A and the lower lines 35B so as to define a boxer short-shaped zone 52 that would underlie the entire harness 30. In any event, it is preferred that the wear reduction structure 50 be limited to only those portions of the garments 10 that require additional wear protection so that the majority of the garments 10 are free from the wear reduction structure 50.

Turning again to FIG. 3, it can be seen that the wear reduction structure 50 is provided in the form of a series of cushioning strips 58 that are spaced throughout the zone 52. The strips 58 can extend in any suitable orientation with respect to the firefighter, and are shown extending horizontally with respect to the firefighter in FIGS. 3 and 4A, and extending vertically with respect to the firefighter as shown in FIG. 4B. With reference to FIG. 4C, the moisture barrier structure 50 can also be provided in the form of discrete cushioning pads 60 that are spaced throughout the zone 52. As another alternative shown in FIG. 5, the wear resistant structure 50 can be provided in the form of an additional layer 62 of material that extend continuously throughout the zone 52. In any of the above forms, the structure 50 can be formed from a single thickness of a suitable material, or from multiple thicknesses of a suitable material, or from batting, foam, or other cushioning material. In one preferred embodiment, the structure 50 is made from the same material as the moisture barrier liner 42, while in another preferred embodiment the structure 50 is made from the same material as the thermal insulating liner 44. In another preferred embodiment, the wear resistant structure 50 is made from a moisture barrier material that has a superior wear resistance in comparison to the material used in the moisture barrier liner 42. One example of a material having superior wear resistance is a tri-laminate form of Crosstech®.

Preferably, the wear reduction structure 50 (in any of its previously described forms) is fixed to either the inner side of the outer shell 40 or the outer side of the moisture barrier liner 42 in any suitable fashion, such as by bonding or by stitching the structure 50 to the outer shell 40 or moisture barrier liner 42.

1. A protective garment for use by a firefighter or other emergency worker in connection with a weight-bearing harness worn by the firefighter or other emergency worker over the exterior of the protective garment, the protective garment comprising:
an outer shell;
a moisture barrier liner within the outer shell; and
a wear reduction structure between the outer shell and the moisture barrier liner to reduce wear of the moisture barrier liner caused by the harness when worn by a firefighter or other emergency worker, the wear reduction structure limited to at least one zone selected to underlie the harness.

2. The protective garment of claim 1 wherein the protective garment is a coat and the wear reduction structure is located in at least one of a waist portion of the coat to underlie a waist harness and a shoulder portion of the coat to underlie a shoulder harness.

3. The protective garment of claim 2 wherein the wear reduction structure extends downward from the waist portion to adjacent a bottom of the coat.

4. The protective garment of claim 2 wherein the coat has a collar and a pair of sleeves and the wear reduction structure extends from the collar to each of the sleeves.

5. The protective garment of claim 1 wherein the protective garment is a pair of pants and the wear reduction structure is located in at least one of a waist portion of the pair of pants and a pair of upper thigh portions of the pants.

6. The protective garment of claim 5 wherein the wear reduction structure is located in the waist portion.

7. The protective garment of claim 6 wherein the wear reduction structure extends from the waist portion to a pair of upper thigh portions of the pants.

8. The protective garment of claim 5 wherein the wear reduction structure is located in each of the upper thigh portions.

9. The protective garment of claim 1 wherein the wear reduction structure comprises a series of cushioning pads spaced throughout the at least one zone.

10. The protective garment of claim 1 wherein the wear reduction structure comprises a series of elongate cushioning strips extending through the at least one zone.

11. The protective garment of claim 10 wherein the strips extend longitudinally with respect to the coat.

12. The protective garment of claim 10 wherein the strips extend transverse with respect to the coat.

13. The protective garment of claim 10 wherein the wear reduction structure comprises an additional layer of material extending throughout the zone.

14. The protective garment of claim 13 wherein the additional layer is made from the same material as the moisture barrier liner.

15. The protective garment of claim 13 wherein the moisture barrier liner and the additional layer are made from different materials.

16. The protective garment of claim 15 wherein additional layer is made from a moisture barrier material having a greater resistance to wear than the material of the moisture barrier liner.

17. The protective garment of claim 16 further comprising a thermal insulative liner located inside of the moisture barrier liner, and wherein the additional layer and the thermal insulative liner are made from the same material.

18. The protective garment of claim 1 wherein the wear reduction structure is fixed to the moisture barrier liner.
